(19) United States
(12) Patent Application Publication
(10) Pub. No.: US 2009/0031097 A1
(43) Pub. Date: Jan. 29, 2009

(54) Creating Backups in Storage Systems

(76) Inventor: Lee Nelson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/829,928

(22) Filed: Jul. 29, 2007

(51) Int. Cl. G06F 12/16

(52) U.S. Cl. 711/162; 711/E12.103

(57) ABSTRACT

Embodiments include methods, apparatus, and systems for creating backups in storage systems. One embodiment includes a method that uses a background process to asynchronously copy data from a production virtual disk (vdisk) to a two-tier mirrorclone on a backup disk in a storage system.

### BACKGROUND

Enterprises commonly maintain multiple copies of important data and expend large amounts of time and money to protect this data against losses due to disasters or catastrophes. In some storage systems, data is stored across numerous disks that are grouped together. These groups can be linked with arrays to form clusters having a large number of individual disks.

Some application vendors and customers require an online backup to be a full copy backup contained on a separate set of disks from the production data. Some storage array customers prefer to use slow, less durable, inexpensive disk drives to contain online backups. Production data, on the other hand, is often stored on a larger number of fast, durable, expensive disk drives. Production drives provide the host workload with optimal performance and reliability. At the same time, backup drives provide a slower, yet less expensive, form of storage.

Existing technologies for creating online backups do no work very well when the backup disks are slower and/or less durable than the production disks. By way of example, backup disks can wear out quickly and cause unwanted downtime during backups. Backup drives also offer less reliability and poorer performance than production drives.

### BRIEF DESCRIPTION OF THE DRAWINGS

FIG. 1 is a block diagram of a cluster storage system in accordance with an exemplary embodiment.

FIG. 2 is a flow diagram for an asynchronous mirrorclone backup in accordance with an exemplary embodiment.

FIG. 3 is a flow diagram for creating a point-in-time backup using a multi-tier mirrorclone in accordance with an exemplary embodiment.

### DETAILED DESCRIPTION

Embodiments are directed to apparatus, systems, and methods for creating online backups on low-performance backup disks with minimal impact to host workload. One embodiment uses a two-tier mirrorclone technique to create online backups in the presence of a two-tier storage system having backup disks that are different (example, slower or less reliable) than productions disks.

Exemplary embodiments use multi-tier storage and provide minimal or no downtime during backups and have minimal or no performance impact on the host workload. These conditions occur even when the backup disks are slower and/or less durable than the production disks. By way of example, die backup drives are provided as FATA drives (Fibre Channel Advanced Technology Attachment drives) while the production data drives are provides as SCSI drives (Small Computer System Interface drives).

Exemplary embodiments are implemented in a multi-tier storage system and satisfy one of more of the following:
1. The storage system creates a full-copy backup on the backup disks.
2. The storage system provides zero-downtime backup capabilities when compared to snapshot, snapclone, and mirrorclone. Data copying or backups occur without taking the system offline. Further, new data is written to the log while the system is in backup mode while copies are being performed.
3. Host-writes to the production disks are disconnected, in terms of performance, from writes to the backup disks at all times. Otherwise, the slowness of the backup disks will become the performance bottleneck.
4. The storage system does not overwork the backup disks since they may be less durable. For example, if the backup disks are less expensive, they might wear more quickly.

In terms of the four criteria, snapclone does create a full-copy backup of the production data on the backup disks. Snapclone, however, uses a copy-before-write (CBW) technique to copy the data. CBW technology works by reading a chunk of production data from the production disks and writing it to the backup disks in an on demand fashion before allowing a new host-write to the production virtual disk (vdisk). The write portion of each CBW goes to the snapclone on the backup disks and will become the performance bottleneck. Because of this negative effect on host workload performance, snapclone does not satisfy all of the four criteria.

Further, in terms of the four criteria, mirrorclone also creates a full-copy backup on the disks. Mirrorclone uses real-time mirroring to keep the online backup in synchronization with the production vdisk. When a host write flushes from cache, the write forks and goes to the production vdisk on the production disks at the same time it goes to the mirrorclone vdisk on the backup disks. A write is not complete until it returns successful status from both the production vdisk and mirrorclone. If the backup disks are slower than the production disks, the backup disks become the performance bottleneck and overall host write speed runs no faster than the backup disks allow. Furthermore, real-time mirroring causes the backup disks to be written just as often as the production disks. If the backup disks are less durable, they will wear out faster. Therefore, this type of mirrorclone does not satisfy all of the four criteria.

As discussed below, one exemplary embodiment uses a modified mirrorclone technique to satisfy all of the four criteria.

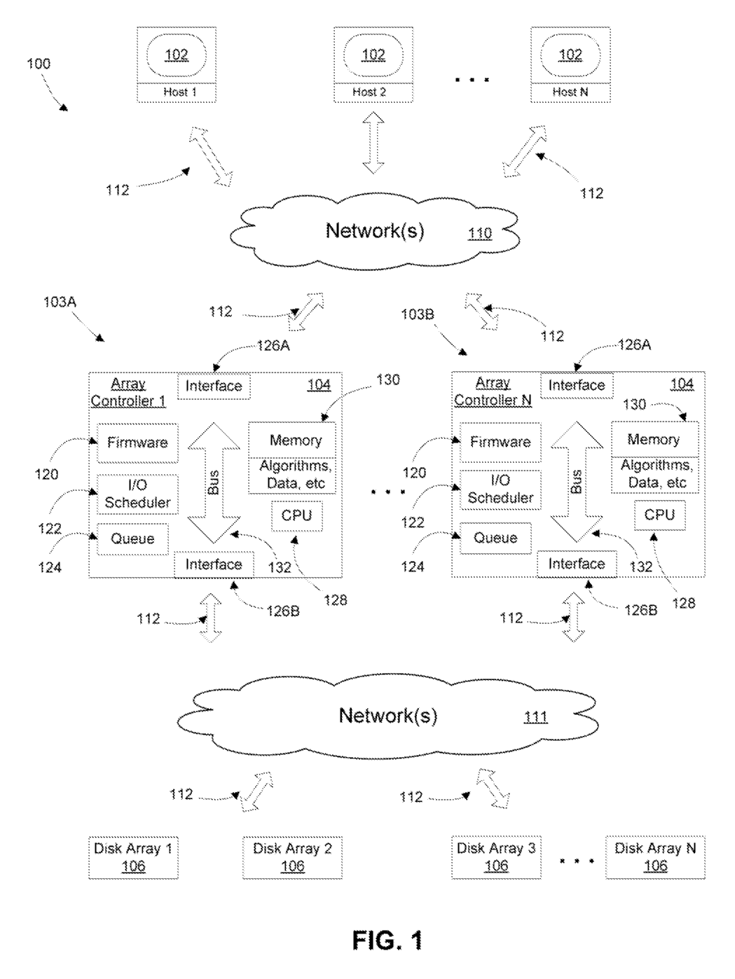

FIG. 1 is a block diagram of an exemplary distributed file or storage system 100 in accordance with an exemplary embodiment of the invention. By way of example, the system is a cluster storage network and/or a storage area network (SAN) that includes a plurality of host computers 102 and one or more storage devices or arrays 103A, 103B that include one or more storage controllers 104 (shown by way of example as an array controller), and a plurality of storage devices 106 (shown by way of example as disk array 1 to disk array N).

The host computers 102 (shown as host 1 to host N) are coupled to the array controllers 104 through one or more fabrics or networks 110, and the storage devices or arrays 103 are coupled to the storage devices 106 through one or more fabrics or networks 111. For instance, the hosts communicate with an array controller using a small computer system interface (SCSI) or other interface/commands over a fiber channel (FC). By way of example, networks 110 and 111 include one or more of the Ethernet, fibre channel (FC), serial attached SCSI (SAS), iSCSI, internet, local area network (LAN), wide area network (WAN), public and/or private networks, etc. Communications links 112 are shown in the figure to represent communication paths or couplings between the hosts, controllers, and storage devices.

In one exemplary embodiment, the array controller 104 and disk arrays 106 are network attached devices providing random access memory (RAM) and/or disk space (for storage and as virtual RAM) and/or some other form of storage such as magnetic memory (example, tapes), micromechanical systems (MEMS), or optical disks, to name a few examples. Typically, the array controller and disk arrays include larger amounts of RAM and/or disk space and one or more specialized devices, such as network disk drives or disk drive arrays, (example, redundant array of independent disks (RAID)), high speed tape, magnetic random access memory (MRAM) systems or other devices, and combinations thereof. In one exemplary embodiment, the array controller 104 and disk arrays 106 are memory nodes that include one or more servers.

The storage controller 104 manages various data storage and retrieval operations. Storage controller 104 receives I/O requests or commands from the host computers 102, such as data read requests, data write requests, maintenance requests, etc. Storage controller 104 handles the storage and retrieval of data on the multiple disk arrays 106 and disk groups. In one exemplary embodiment, storage controller 104 is a separate device or may be part of a computer system, such as a server. Additionally, the storage controller 104 may be located with, proximate, or a great geographical distance from the disk arrays 106 or from each other.

The array controller 104 includes numerous electronic devices, circuit boards, electronic components, etc. By way of example, the array controller 104 includes firmware 120, an input/output (I/O) scheduler 122, a queue 124, one or more interfaces 126, one or more processors 128 (shown by way of example as a CPU, central processing unit), and memory 130 (including read and write cache). CPU 128 performs operations and tasks necessary to manage the various data storage and data retrieval requests received from host computers 102. For instance, processor 128 is coupled to a host interface 126A that provides bidirectional data communications to one or more host computers 102. Processor 128 is also coupled to an array interface 126B that provides bidirectional data communications to the disk arrays 106.

Memory 130 is also coupled to processor 128 and stores various information used by processor when carrying out its tasks. By way of example, memory 130 includes one or more of volatile memory, non-volatile memory, or a combination of volatile and non-volatile memory. The memory 130, for example, stores applications, data, control programs, algorithms (including software to implement or assist in implementing embodiments in accordance with the present invention), and other data associated with the storage device (example, state data such as mapping metadata, configuration metadata, and cached user data). The processor 128 communicates with memory 130, interfaces 126, and the other components via one or more buses 132.

In at least one embodiment, the storage devices are fault tolerant by using existing replication, disk logging, and disk imaging systems and other methods including, but not limited to, one or more levels of redundant array of inexpensive disks (RAID). Replication provides high availability when one or more of the disk arrays crash or otherwise fail. Further, in one exemplary embodiment, the storage devices provide memory in the form of a disk or array of disks where data items to be addressed are accessed as individual blocks stored in disks (example, 512, 1024, 4096, etc. . . . bytes each) or stripe fragments (4K, 16K, 32K. etc. . . . each).

In one exemplary embodiment, the I/O scheduler manages and schedules processor time for performing I/O requests. The scheduler balances loads and prevents any one process from monopolizing resources while other processes starve for such resources. The scheduler further performs such functions as deciding which jobs (example, I/O requests) are to be admitted to a ready queue, deciding a number or amount of processes to concurrently execute, determining how performance (example, bandwidth or I/Os per second) is divided among plural initiators (example, applications) so each initiator receives optimal performance.

In one embodiment the storage devices 103A, 103B are disk arrays. Each disk array can have one or more controllers. For instance, an array has two controllers for redundancy. Further, the storage devices include both production disks and backup disks as discussed herein.

In one embodiment, storage devices 103A, 103B are physically located in a same data center. In another embodiment, the storage devices are located a great geographical distance apart in separate data centers. Further, although only two storage devices are shown, a SAN can include hundreds or thousands of such storage devices.

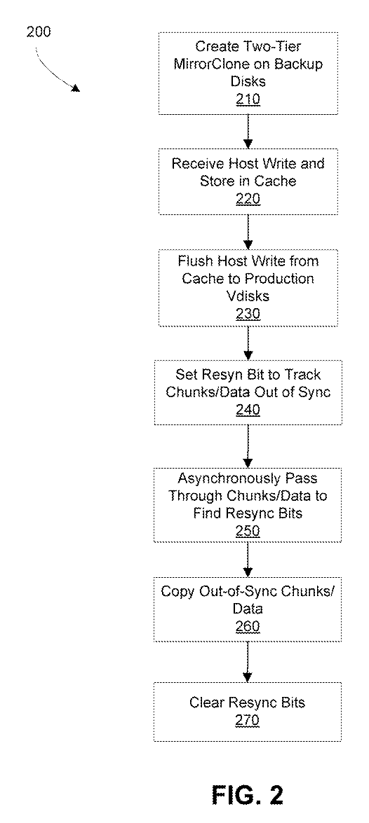

FIG. 2 is a flow diagram 200 for an asynchronous mirrorclone backup in accordance with an exemplary embodiment.

According to block 210, a two-tier mirrorclone is created on one or more backup disks. By way of example, the backup disks are slower, less expensive, and/or less reliable than production disks.

Then, according to block 220, host writes are received and stored in cache memory.

According to block 230, the host writes are flushed from the cache to the production vdisks. In traditional mirrorclone, the host write flushes from cache and forks to both the production vdisk on the production disks and at the same time goes to the mirrorclone vdisk on the backup disks. In this instance, however, once a host write is flushed from cache, the host write proceeds to the source Vdisk but not to the mirrorclone. This new type of mirrorclone uses a background process that asynchronously copies new data from the production vdisk to the 2-tier mirrorclone. Specifically, the a host-write is not forked to the 2-tier mirrorclone. In other words, the 2-tier mirrorclone does not become “in-synch” with the production vdisk. Instead, each host write goes to the production vdisk only and causes a resync bit to be set if necessary.

According to block 240, a resynchronization (resync) bit is set to track chunks or data out of synchronization (sync). Resync bits are used to track the differences between the source vdisk and mirrorclone. In other words, the resync bits are used to track which chunks of data are out of sync with the production vdisk. Setting resync bits has little host-write performance impact, especially since the resync bits can be stored in memory or on the fast production disks. Once a resync bit is set for a particular chunk, the resync bit does not have to be set again for host-writes to that chunk.

According to block 250, passes are made through the chunks or data to discover resync bits. In other words, while the host workload is setting resync bits and writing to the production vdisk, a background resync process is asynchronously making passes through the chunks finding resync bits.

According to block 260, out-of-sync chunks or data are copied. These out-of-sync chunks of data are copied from the production vdisk to the 2 tier mirrorclone.

According to block 270, resync bits are cleared.

The background process is not expected to work the backup disks nearly as hard as the production vdisks are being worked by the host workload. As a result, the lesser durability of the backup disks should not be a problem.

The resync background process can also be implemented in a variety of ways to minimize thrashing. For example, it makes an initial pass through the resync bits just to create a full-copy of the user data on the 2-tier mirrorclone. It then makes a pass through the chunks every hour or two looking for data to refresh. Alternatively, it waits until some threshold of resync bits have been set before performing a scan.

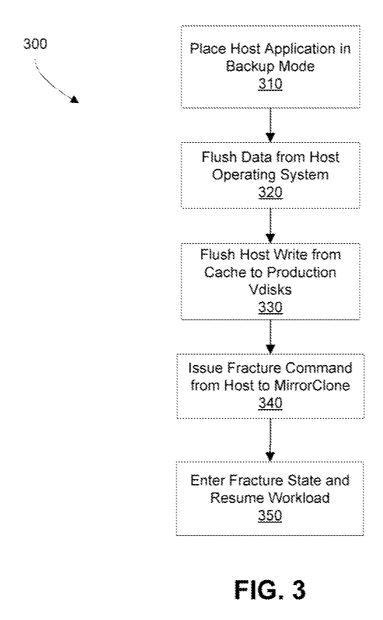

FIG. 3 is a flow diagram 300 for creating a point-in-time backup using a multi-tier mirrorclone in accordance with an exemplary embodiment. Exemplary embodiments provide zero downtime backup capabilities for copying data to the backup disks.

Exemplary embodiments enable the creation of a consistent point-in-time backup using the multi-tier mirrorclone. Regular mirrorclone has a “fracture” operation that performs such a task. The fracture command causes the mirror clone to become a point-in-time consistent copy of the source vdisk by flushing the cache. Immediately after the fracture, host writes proceed to the source vdisk but not to the mirrorclone. Resync bits are used to track the differences between the source vdisk and mirrorclone.

According to block 310, host applications are placed into a backup mode. In other words, before issuing a fracture command, host applications are quieseed or put into backup mode. This allows the host applications to stop using data and leave the data in a consistent state.

According to block 320, all data is then flushed from the host operating system (OS) to the storage device.

According to block 330, the host issues a fracture command to the mirrorclone. The fracture command causes all data stored in cache to be flushed.

According to block 340, after the flush, the mirrorclone enters a fractured state and the host workload is resumed.

While in a fractured state, the mirrorclone contains a consistent point-in-time (PIT) copy. New writes to the production vdisk are no longer forked to the mirrorclone. Instead, new writes go to the production vdisk and a resync bit is set for the corresponding chunk if such a bit is not already set.

In one exemplary embodiment, the two-tier mirrorclone has a fracture operation. When the fracture command is issued, a two-tier snapshot is attached to the production vdisk. This snapshot is created on the production vdisks to provide instant fracture capability. A regular mirrorclone would have to be fully in-synch to fracture. A two-tier mirrorclone, however, uses the two-tier snapshot to track and temporarily contain point-in-time-copy data that has not yet been copied to the two-tier mirrorclone. Thus, the data in the two-tier snapshot combined with the data in the two-tier mirrorclone will always equal a full point in-time copy of the user data. The two-tier mirrorclone will then enter a “finalizing” state as the resync background process continues to run.

The instant the two-tier snapshot is attached, the host workload is allowed to proceed—thus allowing for “zero-downtime” backup like regular snapshot, snapclone, and mirrorclone provide. The host workload will cause CBW to happen, but since the two-tier snapshot exists on the production vdisks, the host workload remains isolated from the slowness of the backup disks.

The amount of time the two-tier mirrorclone stays in the finalizing state depends on how long it takes the resync background process to copy the remaining data that is not in-synch and copy the data that will start to be deposited in the two-tier mirrorclone.

When the mirrorclone is fractured from the source vdisk a bitmap is created that tracks the changes occurring on the source vdisk and/or on the mirrorclone. For example, when a host write to the production vdisk occurs, either a CBW will happen to the two-tier snapshot or a secondary resync bit will be set. A separate “secondary” resync bitmap, (example, associated with the two-tier snapshot) can be used during the finalizing state. These secondary resync bits track changes to the production vdisk while the two-tier mirrorclone is finalizing. They will be used later so the two-tier mirrorclone can do a delta resync as opposed to a full copy. In a traditional mirrorclone, the delta resync brings the mirrorclone back into sync with the source vdisk using a resync bitmap that acts as a performance enhancement because only the delta data is resynched.

In one exemplary embodiment, when a host-write Hushes to the production vdisk for a particular chunk the first time after the two-tier mirrorclone has entered the finalizing state, it follows the following two-tier snapshot unsharing rules: First, if the resync bit is not already set, the two-tier mirrorclone already contains the PIT data, so just write to the production vdisk and set the secondary resync bit for tracking. Second, if the resync bit is already set, do a CBW to the two-tier snapshot. The secondary resync bit needs to be set, but one embodiment lets the background resync process set it later.

These unsharing rules for a two-tier snapshot are different than for a normal snapshot. The performance of a two-tier snapshot is as good or better at all times than a normal snapshot because the only time a CBW occurs is when the corresponding resync bit is already set. For example, one worst-case scenario occurs if all resync bits are set, which would result in performance almost identical to regular snapshot. As the resync background process copies data and clears remaining resync bits, the odds of a host write causing a CBW will also decrease. This further increases the host workload performance. In one exemplary embodiment, only the first write to a chunk performs the above steps. Subsequent writes to the chunk, do nothing special since the CBW has already been dealt with or the setting of the secondary resync bit has already been dealt with.

The following provides a discussion of resync background process rules. During finalizing, the resynch background process uses one or more of these rules for each chunk: First, if the resync bit is set and the two-tier snapshot is still shared, copy the data from the production vdisk and clear the resync bit. Second, if the resync bit is set and the two-tier snapshot is not shared, copy the data from the snapshot since it contains the PIT copy of the data. Third, if the resync bit is not set and the snapshot is still shared, take no action because the PIT copy of the data is already contained in the two-tier mirrorclone. Fourth, if the resync bit is not set and the snapshot is not shared, copy the data from the snapshot and set the secondary resync bit. This is the case where a write came in after the two-tier mirrorclone entered the finalizing state. For optimal host workload performance, the resync background process can set the secondary resync bit rather than making the host workload perform this action.

The resync background process will eventually process all the resync bits and all the two-tier snapshot unshared data. At that point, the two-tier mirrorclone will contain a consistent full copy of the point-in-time image of the data. The two-tier snapshot will then be detached from the production vdisk and can be drained or deleted. The secondary resync bits will be copied to the regular resync bit area, and the two tier mirrorclone will change state to fractured. At this point, two-tier mirrorclone can be used like a normal fractured mirrorclone. For example, a snapshot can be created of the two-tier mirrorclone, it can be presented to the host for I/O, it can be detached, delta resynched, or can be used for an instant restore back to the production vdisk.

As used herein, two tier storage, two-tier storage, or multi-tier storage means a data storage environment including two or more kinds of storage delineated by differences in at least one of four attributes: price, performance, capacity and function. A significant difference in one or more of the four defining attributes is sufficient to justify a separate storage tier. Examples of two tier storage include, but are not limited to, (1) using both disk (example, hard disk drive) and tape (example, magnetic tape) to store date, (2) using old technology or slower disk drives and new technology or faster disk drives, (3) using high performance storage and lesser expensive or slower disks of the same capacity and function, (4) using more reliable storage for production data and less reliable storage for backup data, etc. Further, storage tiers are not delineated by differences in vendor, architecture, or geometry unless such differences result in a clear change to one of price, performance, capacity, and function.

As used herein, the term “storage device” means any data storage device capable of storing data including, but not limited to, one or more of a disk array, a disk drive, a tape drive, optical drive, a SCSI device, or a fiber channel device. As used herein, a “disk array” or “array” is a storage system that includes plural disk drive, a cache, and controller. Arrays include, but are not limited to, networked attached storage (NAS) arrays, modular SAN arrays, monolithic SAN arrays, utility SAN arrays, and storage visualization. As used herein, a “target port” is an interlace on an electronic device that receives I/O requests and/or data. As used herein, an “initiator port” is an interface on an electronic device that transmits I/O requests and/or data.

As used herein, a “vdisk” or “virtual disk” is a virtual logical disk or volume to which a host or application performs input/output (I/O) operations. By way of example, vdisks are used in Fibre channel and SAN infrastructures. Disks are virtual due to the method by which they are mapped to the physical storage capacity. In some virtual storage systems, a meta-data mapping table translates an incoming (virtual) disk identifier and LBA (logical block addressing) to a physical disk identifier and LBA. The visualization granularity depends on the implementation. Some visualized systems provide disk aggregation and so the granularity is a physical disk itself. Other visualization systems actually break down the physical disks into smaller chunks or extents. These latter systems spread a single virtual disk across many physical disks, obtain more concurrent access than a non-visualized system, and provide a performance benefit.

Further, as used herein, a “mirroclone” or “mirror clone” is a mirror copy of the source vdisk that can stay synchronized with the source vdisk or can be split off to form a point-in-time copy. Further, a “source vdisk” is the source LUN that contains the production data. The term “mirror link” means the mirroring that occurs between the source vdisk and the mirror clone. Further yet, the terms “quiesce” and “unquiesce” mean the stopping and restarting of host I/O. The term “CBW” or “copy-before-write” means allowing a snapshot to maintain its point-in-time status such that before new data is written, the old data is copied into the snapshot.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

Incorporated herein by reference are a first patent application entitled “Data Restore Operations in Storage Network” having attorney docket number 200506200-1 and naming as inventors Aaron Lindemann, Xia Xu, Rodger Daniels, and Lee Nelson and a second patent application entitled “Copy Operations in Storage Networks” and having attorney docket number 200402798-1 and naming as inventors Rodger Daniels, Lee Nelson, and Andrew Dallmann.

The above discussion is meant to be illustrative of the principles and various embodiments of the present invention. Numerous variations and modifications will become apparent to those skilled in the art once the above disclosure is folly appreciated. It is intended that the following claims be interpreted to embrace all such variations and modifications.

What is claimed is:

1) A method, comprising:
using a background process to asynchronously copy data from a production virtual disk (vdisk) to a two-tier mirrorclone on a backup disk in a storage system.

2) The method of claim 1 further comprising, setting resync bits while writing to the production vdisk, the resync bits tracking which chunks of data are out of synchronization.

3) The method of claim 1, wherein the backup disk has slower read and write performance than a production disk for the production vdisk.

4) The method of claim 1, wherein the two-tier mirrorclone does not become in-sync with the production vdisk.

5) The method of claim 1 further comprising, using the background process to asynchronously pass through chunks of data that are out of sync to find resync bits.

6) The method of claim 1 further comprising:
copying out-of-sync chunks of data from the production vdisk to the two-tier mirrorclone:
clearing resync bits.

7) The method of claim 1 further comprising, using the background process to pass through resync bits to create a full-copy of user data on the two-tier mirrorclone.

8) A computer readable medium having instructions for causing a computer to execute a method, comprising:
asynchronously copying data from a production virtual disk (vdisk) to a multi-tier mirrorclone on backup disks by setting resync bits that track which chunks of data are out of sync.

9) The computer readable medium of claim 8 further comprising, passing through the chunks of data to discover the resync bits and copying out-of-sync chunks of data from the production vdisk to the multi-tier mirrorclone.

10) The computer readable medium of claim 8 further comprising, attaching a two-tier snapshot to the production vdisk after issuing a fracture command.

11) The computer readable medium of claim 8 further comprising, using a two-tier snapshot to track and contain point-in-time copy data that has not yet been copied to the multi-tier mirrorclone.

12) The computer readable medium of claim 8 further comprising, creating a two-tier snapshot, wherein data in the two-tier snapshot combined with data in the multi-tier mirrorclone equals a full point-in-time copy of user data.

13) The computer readable medium of claim 8 further comprising:
initiating a copy-before-write (CBW);
isolating a host from slowness of the backup disks by attaching a two-tier snapshot to the production vdisk.

14) The computer readable medium of claim 8 further comprising, using secondary resync bits to track changes to the production vdisk while the multi-tier mirrorclone is finalizing.

15) The computer readable medium of claim 8 further comprising, writing to the production vdisk and setting resync bits for tracking when a host-write flushes to the production vdisk for a particular chunk after the multi-tier mirrorclone enters a finalizing state.

16) The computer readable medium of claim 8 further comprising, performing a copy-before-write (CBW) when a host-write flushes to the production vdisk for a particular chunk after the multi-tier mirrorclone enters a finalizing state.

17) A method, comprising:
asynchronously copy data with a background process from virtual disks (vdisks) to a multi-tier mirrorclone on backup disks in a storage system.

18) The method of claim 17 further comprising, reading and writing data onto the backup disks at slower rates than reading and writing data onto the vdisks.

19) The method of claim 17 further comprising, copying data from the vdisks and clearing resync bits if a resync bit is set and a two-tier snapshot is shared.

20) The method of claim 17 further comprising, copying data from a snapshot if a resync bit is set and a two-tier snapshot is not shared.
